(19) United States
(12) Patent Application Publication
(10) Pub. No.: US 2007/0018104 A1
(43) Pub. Date: Jan. 25, 2007

(54) Machine for detecting sulfur hexafluoride (SF6) leaks using a carbon dioxide laser and the differential absorption lidar ( DIAL) technique and process for making same

(76) Inventors: Parviz Parvin, Tehran (IR); Hasan Kariminejad, Tehran (IR)

Correspondence Address: Parviz Parvin;Unite 7, No 6 Lida Street, Valiasr Avenue - Vanak Square, Terhran, 19697, IR

(21) Appl. No.: 11/487,923

(22) Filed: Jul. 17, 2006

(30) Foreign Application Priority Data
Jul. 25, 2005 (IR) 38405038

(51) Int. Cl. G01N 21/35

(52) U.S. Cl. 250/339.13

(57) ABSTRACT

A machine for detecting sulfur hexafluoride (SF6) leaks using the mid-infrared differential absorption lidar (DIAL) technique with a commercically available, air-cooled, compact, pulsed transversely-excited-atmospheric (TEA) carbon dioxide (CO.sub.2) laser, a Cassegranian optical telescope for focusing both the laser emission and returning reflected signal, a user-operated focusing mechanism, a two-dimensional, thermoelectrically-cooled focal plane array (FPA) sensitive in the mid-infrared wavelength range (10.2-10.6 micrometers), a charge-coupled device (CCD) for 2-D imaging, a computer-based control system to rapidly switch the laser wavelength between 10.2470 micrometers, 10.7415 micrometers, and 10.5518 micrometers to utilize the Differential Absorption Lidar (DIAL) chemical detection technique, a rechargeable battery pack and power supply, and an image and data storage device using a solid-state memory stick.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of remote sensing, and more specifically to a machine for detecting sulfur hexafluoride (SF6) leaks using a carbon dioxide (CO2) laser and the infrared differential absorption lidar (DIAL) technique and process for making same.

Sulfur hexafluoride (SF6) is an excellent insulator widely used in the electric power industry, primarily in high voltage switches. However, SF6 is a significant green house gas, 23,900 times more damaging than carbon dioxide, and is costly to the utility industry. Therefore, the electric utility industry regularly inspects its transmission facilities for SF6 leaks. In the past, detecting leaks was a crude process utilizing visual inspection methods, which is time consuming and expensive. Recently, laser-based SF6 inspection tools have become available.

The current commercial state-of-the-art is the “GasVue” line of laser-based SF6 inspection systems produced by Laser Imaging Systems (LIS) of Florida. In particular, the GasVue TG-30 camera system is being used by utilities to image SF6 leaks. This camera system uses a continuous wave (CW) carbon dioxide (CO2) laser along with raster scanning to obtain a two-dimensional (2-D) image of the SF6 leak. The CW CO2 laser runs at powers of 3-8 watts average power, and utilizes the “Backscatter Absorption Gas Imaging” (BAGI) technique. The BAGI technique requires a reflective or backscatering surface behind the SF6 leak, such that open air imaging of SF6 is not possible, and the range of the TG-30 device is limited to 20-30 meters from the leak. The BAGI technique cannot give quantitative concentration information regarding the size of the SF6 leak, but rather is a useful tool for visualizing SF6 leaks in a 2-D image by the user.

Another laser-based SF6 imaging technique is the “Image Multi-Spectral Sensing” (IMSS) technique. In the IMSS approach, a diffractive element is used to perform both imaging and dispersion of light. The diffractive optical element disperses light along the optical axis and the detector array focal length is scanned to produce images of different wavelengths. The advantage of this approach is that the entire input aperture collects the light as opposed to the narrow entrance slit and thus the throughput is greater. The IMSS technique does not require a backscattering surface, as does the BAGI technique, and can be used at long ranges (up to miles). However, the IMSS technique is not quantitative, such that the size of the SF6 leak cannot be determined. A commercial IMSS camera for SF6 detection has been developed by Pacific Advanced Technology (PAT) under the “Sherlock” name.

The “Differential Absorption Lidar,” (DIAL) technique is based on the differential absorption and scattering effect (DAS). With DIAL, two laser beams are sent to the target, with one beam tuned to an absorption line of the molecule of interest (i.e. SF6), and the other laser beam tuned away from the absorption band to monitor the background response of the atmosphere. The large Mie scattering cross section of the beam interfering with the gas molecules results in high sensitivity and good spatial resolution of the backscattered signal collected by the camera system. In combination with the higher power available with a pulsed CO2 laser, the DIAL technique allows for quantitative measurements of SF6 leaks at long range (100's of meters). The DIAL technique employed with a compact, pulsed CO2 laser and camera system is the essence of the current invention.

In U.S. Pat. No. 4,450,356 issued to Murray et al., a frequency-mixed carbon dioxide (CO2), laser beam is used for remote detection of gases in the atmosphere. The laser beam system uses frequency doubling and frequency summing in crystals to produce wavelengths near three micrometers. Means for selecting many wavelengths are disclosed, but delivery of only two mid-infrared wavelengths to a topographic target are disclosed. CO2 lasers are continuously not tunable and lack strong lines at wavelengths coincidental with acceptable methane and ethane lines.

In U.S. Pat. No. 4,489,239, a 25 meter short distance portable remote laser sensor is described for detecting methane gas pipeline leaks by Grant et al. The system requires the use of two separate helium-neon (He—Ne) lasers. The two lasers operate at two different on and off methane signature wavelengths, each of which is fixed. He—Ne lasers are typically not tunable and not as efficient and reliable as solid-state lasers.

Similarly, In U.S. Patent Application Publication 2003/0030001 A1, Cooper et al disclose the use of a tunable diode laser to detect gases in the atmosphere. This system does not allow for real-time compensation for variability in the background target reflectivity and cannot measure multiple gas species nearly simultaneously, a critical requirement for scanning and remote sensing systems that detect pipeline leaks.

In U.S. Pat. No. 4,871,916, a laser system is described by Scott that uses neodymium lasers for remote sensing of methane in the atmosphere to detect conditions approaching dangerous or explosive levels in a mine. In this system, the wavelength region is nearly at 1.318 micrometers. This system only discloses detection of methane and does not allow for real-time compensation for variability in the background target reflectivity.

In U.S. Pat. Nos. 5,157,257 and 5,250,810 assigned to Geiger, a mid-infrared DIAL system is described. This specific system uses six distinct coherent beams formed by six different pulsed lasers at wavelengths 2.2 to 2.4 or 3.1 to 3.5 micrometers to detect light hydrocarbons. The six coherent beams are fully time-multiplexed and combined into a single beam through selective polarization. Quartz crystals are used for polarization. The quartz crystals are easily damaged by high-energy laser pulses and complexity of this system is not conducive to use in the field, particularly in airborne remote sensing applications. Also, the laser spectral width is too broad to resolve the absorption bands of many key gases.

In U.S. Pat. No. 6,509,566 B1 assigned to Wamsley et al., a mid-infrared DIAL system is also described for the purposes of oil and gas exploration. The system disclosed includes a single Cr:LiSAF laser with a hydrogen Raman cell to produce wavelengths in a range suitable for hydrocarbon detection. The laser is water-cooled and continuously tunable at a single wavelength. This system does not conveniently allow for real-time compensation for variability in the background target reflectivity and simultaneous detection of other gases. Furthermore, the single laser frequency is referenced to an external frequency meter and is, therefore, subject to drift that negatively affects the electronic components in the system.

BAGI is an existing and patented technique disclosed in U.S. Pat. No. 4,555,627, titled “Backscatter absorption gas imaging system”. Simply stated, the patent covers the use of infrared laser-illuminated imaging for the remote video visualization of gas plumes. It describes the coupling of an infrared laser to an infrared camera to produce an instrument that views a scene in the infrared as the laser illuminates the scene. The system produces, therefore, a laser-illuminated video picture of the scene. If a gas plume is present that can absorb light at the center wavelength, it creates a shadow in the picture that is essentially a video image of the gas plume. BAGI is currently being commercialized by Laser Imaging Systems (LIS), which offers systems operating in the 9-11 micrometer wavelength range based on the use of CO2 lasers.

U.S. Pat. No. 3,317,730 discloses a method for determining atmospheric pollution by the detection of backscattered modulated infrared radiation.

U.S. Pat. No. 3,832,548 to Wallack shows a general infrared absorption detector in which infrared radiation first passes through a filter means having a plurality of positions for transmitting selected wavelengths, and then passes through a sample cell to a detector.

U.S. Pat. No. 4,204,121 to Milly shows a mobile detector comprising a vertical sampling array for quantifying emission rates from pollution sources.

U.S. Pat. No. 4,264,209 to Brewster shows a system for producing an indication of a concentration of a gas of interest in which the gas is illuminated and the output is filtered alternately with two filters, one at an absorption band of a gas to be detected, the other at a passband outside the absorption band.

U.S. Pat. No. 4,262,199 to Bridges, et al., shows a mobile infrared target detection and recognition system including an assembly of infrared detection elements which scan a field of view to produce a signal representative of the infrared level from point to point.

U.S. Pat. No. 3,829,694 to Goto discloses apparatus for detecting gases or particles using Mie scattering of pulsed light beams to detect resonance absorption.

U.S. Pat. No. 3,517,190 to Astheimer discloses a method for monitoring stack effluent from a remote position by illuminating the effluent across a broad spectral band and detecting the reflected illumination in two spectral regions: one in an absorption band and one outside the absorption band to determine the quantity of absorbing gas from the signal ratio.

The publication Kulp et al., “Development of a pulsed backscatter-absorption gas-imaging system and its application to the visualization of natural gas leaks”, Appl. Opt. 37 3912-3922 (1998), describes the development of a pulsed BAGI imager that uses full-field illumination at a laser pulse repetition rate of 30 Hz.

The publication Powers et al. “Demonstration of differential backscatter absorption gas imaging”, Appl. Opt. 39 1440-1448 (2000) described the development of a pulsed BAGI imager that uses full-field illumination at a laser repetition rate of 30 Hz and is capable of differential detection. It operates in a way that is adversely affected by system motion.

The publication of Imeshev et al. “Lateral patterning of nonlinear frequency conversion with transversely varying quasi-phase-matching gratings” Optics Letters 23 673-675 (1998) describes the use of periodically poled lithium niobate with lateral patterning to produce second harmonic frequency output beam with a flat-topped spatial profile.

Both the BAGI and IMSS techniques cannot quantify the size of the SF6 leaks. By using the DIAL technique, the size of the leak to a down to sub part-per-million (ppm) resolution can be realized. Unlike the BAGI technique, the DIAL technique does not require a backscattering surface behind the leak. Also, due to the use of a much more powerful, pulsed CO2 laser source, the present invention can quantitatively detect SF6 leaks up to 100's of meters from the user. The IMSS technique is passive, meaning no SF6 probing source such as a laser is used, so the only improvement to the IMSS technique would be in detector efficiency. Due to recent advances in compact CO2 lasers and focal pane arrays, a compact laser-based SF6 leak detection camera based on the DIAL technique can be designed which can quantitatively image leaks at ranges up to 100's of meters.

### BRIEF SUMMARY OF THE INVENTION

The primary object of the invention is to provide a laser-based camera system which can detect sulfur hexafluoride (SF6) leaks.

Another object of the invention is to provide a rugged and compact camera system which can be used outdoors in the field.

Another object of the invention is to provide a camera system which can detect SF6 at the sub part-per-million (ppm) level.

A further object of the invention is to provide a camera system which can detect SF6 leaks at ranges of 100's of meters and can quantify the distance to the leak.

Yet another object of the invention is to provide a camera system which can be used for 2-D imaging of a SF6 leak plume.

Still yet another object of the invention is to provide a camera system which has a minimum of components.

Another object of the invention is to provide a camera system which can be used on battery power only for several hours.

Another object of the invention is to provide a turn-key camera system requiring minimal manipulation by the user.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for detecting sulfur hexafluoride (SF6) leaks using a carbon dioxide (CO2) laser and the mid-infrared differential absorption lidar (DIAL) technique comprising: a commercially available, air-cooled, compact, pulsed Transversely Excited Atmospheric (TEA) carbon dioxide (CO2) laser, a Cassegrainian optical telescope for focusing both the laser emission and returning reflected signal, a user-operated focusing mechanism, a two-dimensional, thermoelectrically-cooled focal plane array (FPA) sensitive in the infrared wavelength range (10.2-10.6 micrometers), a charge-coupled device (CCD) for 2-D imaging, a computer-based control system to rapidly switch the laser wavelength between 10.2470 micrometers, 10.7415 micrometers, and 10.5518 micrometers to utilize the Differential Absorption Lidar (DIAL) chemical detection technique, a rechargeable battery pack and power supply, and an image and data storage device using a solid-state memory stick.

In accordance with a preferred embodiment of the invention, there is disclosed a process for detecting sulfur hexafluoride (SF6) leaks using a carbon dioxide (CO2) laser and the infrared differential absorption lidar (DIAL) technique comprising the steps of: a commercially available, air-cooled, compact, pulsed Transversely Excited Atmospheric (TEA) carbon dioxide (CO2) laser, a Cassegerainian optical telescope for focusing both the laser emission and returning reflected signal, a user-operated focusing mechanism, a two-dimensional, thermoelectrically-cooled focal plane array (FPA) sensitive in the infrared wavelength range (10.2-10.6 micrometers), a charge-coupled device (CCD) for 2-D imaging, a computer-based control system to rapidly switch the laser wavelength between 10.2470 micrometers, 10.7415 micrometers, and 10.5518 micrometers to utilize the Differential Absorption Lidar (DIAL) chemical detection technique, a rechargeable battery pack and power supply, and an image and data storage device using a solid-state memory stick.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic diagram illustrating the compact DIAL device, including a mini TEA-CO2 laser, Cassegrainian telescope, focusing lens, focal plane array (FPA), charge-coupled device (CCD), and computer processor.

FIG. 2 is a picture of the Edinburgh Instruments MTL-3 mini TEA CO2 laser.

FIG. 3 is a detailed vibrational-rotational energy level diagram for the CO2 laser transition, including the primary 10.6 micrometer band.

FIG. 4 is a high resolution rotational line spectrum for SF6 in the 10.6 micrometer wavelength range of the CO2 laser emission.

Table I shows the wavelengths of the P-branch rotational transitions and one R-branch transition of the CO2 laser emission within the peak absorption band of the SF6 molecule. The P-16 (10.5518 micrometers) and P-34 (10.7415 micrometers) rotational lines are highlighted as wavelengths to be used to probe the SF6 leaks for 32-SF6 and 34-SF6 isotopes, respectively. The R-20 (10.2470 micrometers) rotational line is to be used as the background probe beam wavelength detuned from the SF6 absorption band.

FIG. 5 is a graphical representation of the collected DIAL signal versus range R for a gaseous plume of SF6.

FIG. 6 is a graphical illustration of the process of obtaining a quantitative measurement of the size and location of a SF6 leak. Graph (a) shows the basic measurement before any processing of the data; graph (b) shows the natural logarithm of graph (a); and graph (c) is the derivative of graph (b) with respect to range R.

FIG. 7 is a schematic diagram depicting the large-scale DIAL experiment used for proving the concept that DIAL can be used to detect SF6 leaks with ppm resolution. FIG. 7(a) shows two CO2 lasers, two helium-neon alignment lasers, and associated optics and computer processors; FIG. 7(b) depicts the Cassegrainian telescope used in the experiments, and proposed for use in the compact camera of the present invention.

FIG. 8 is a picture of the large-scale DIAL experiment comprising the elements shown in FIG. 7.

FIG. 9 is a graph of one set of data collected in the large-scale DIAL experiment. FIG. 9(a) depicts the logarithm of the collected DIAL signal versus range R; FIG. 9(b) depicts the same data on a decimal scale showing that the SF6 leak occurs between 680-690 meters from the user.

FIG. 10 shows the overall results of collected signal versus the size of the SF6 leak. FIG. 10(a) depicts signal versus number density of the 32-SF6 isotope; FIG. 10(b) depicts signal versus 32-SF6 in ppm.

FIG. 11 shows the overall results of collected signal versus the size of the SF6 leak. FIG. 11(a) depicts signal versus number density of the 34-SF6 isotope; FIG. 11(b) depicts signal versus 34SF6 in ppm.

FIG. 12 shows a comparison of the SF6 leak detection results from the large-scale DIAL experiment for both the 32- and 34-SF6 isotopes. FIG. 12(a) depicts signal versus number density of SF6; FIG. 12(b) depicts signal versus SF6 in ppm.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

New sensors for remote monitoring of specific gaseous agents or other pollutants released into the environment are currently being developed by various groups using multiple techniques, as highlighted in the previous sections. A number of the optical remote-sensing techniques for detecting, identifying and quantifying signature of the plumes are possible, including the infrared differential absorption lidar (DIAL) technique. To detect gaseous leaks of sulfur hexafluoride (SF6), the DIAL technique is ideal since it can be used to image the SF6 plume, quantify the size of the leak, and can be used at a range of 100's of meters from the leak source. The DIAL technique is therefore superior to the BAGI and IMSS techniques also being investigated as other means to detect SF6 leaks. The current invention combines existing technologies along with the DIAL procedure to create a new, compact, laser-based SF6 leak detection camera.

Differential Absorption Lidar (DIAL) is based on the differential absorption and scattering effect (DAS). Using DIAL, two laser beams are sent to the target, with one tuned to the wavelength of an absorption line of the molecule of interest (λon) and the other detuned off the absorption peak (λoff) to monitor the background response of the atmosphere. Most of the absorption bands of interest lie in the infrared and correspond to vibrational—rotational transitions. High sensitivity with good spatial resolution is achieved by the combination of differential absorption and scattering (DAS). With DAS, the relatively large Mie scattering cross section is employed to provide spatial resolution and to ensure a strong return signal at both wavelengths, while the ratio of the signals yields the required degree of specificity in the location of the leak due to differential absorption. These advantages bestow upon DAS the greatest sensitivity for long-range monitoring of specific molecular constituents. The efficiency of the DAS technique is dependent on detector sensitivity. Recent improvements in infrared detectors have given the DAS approach more universal appeal.

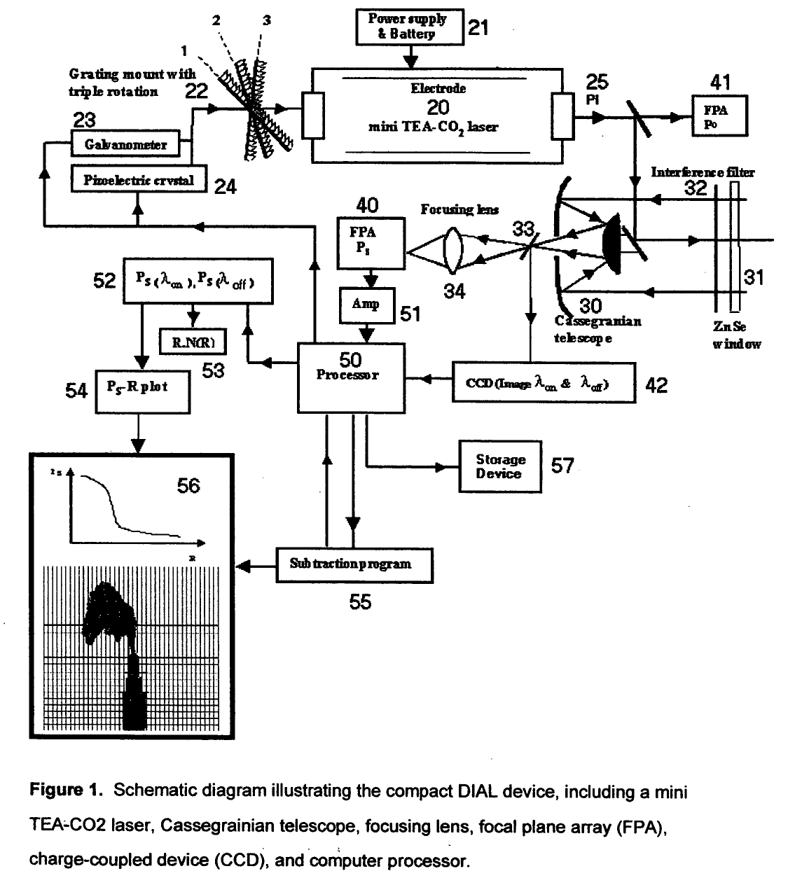

A schematic diagram is shown in FIG. 1 for the proposed new camera system for SF6 leak detection based on the DIAL concept. In FIG. 1, item 20 is a commercially available mini transversely-excited-atmospheric (TEA) carbon dioxide (CO2) laser. Item 21 is the external power supply for the laser, which is typically provided with the laser purchase, and the rechargeable battery pack for field use of the camera system. Item 22 is a diffraction grating (100 lines/mm, 3×3 cm² gold coated littrow 30 blazing angle), which is used to adjust the wavelength of the output laser beam (i.e. switching from λon to λoff). Items 23 and 24 are the galvanometer and piezoelectric crystal, respectively, which are used to precisely move the diffraction grating (item 22) to the appropriate angle. The galvanometer is used for rough tuning and piezoelectric crystal is utilized for fine-tuning. Item 25 is the resulting output beam power, PI, emanating from the laser. Item 30 is the compact Cassegrainian telescope used both to direct the laser beam forward towards the SF6 leak, and to collect the resulting backscattered signal returning from the SF6 molecules. The Cassegrainian design allows for high backscattered signal acceptance, much better than the more standard Newtonian telescope performance. Although the Cassegrainian design is not new, implementing it in a compact fashion in the present invention is new. Item 31 is a zinc-selenium (ZnSe) window, which is transparent to the laser beam and returning backscattered signal. Item 32 is an interference filter used to eliminate unwanted wavelengths outside the 10.2-10.6 micrometer window for the DIAL measurements. Item 33 is a standard beam splitter used to separate part of the returning signal for 2-D imaging and the remaining signal for DIAL measurement of the SF6 location and size. Item 34 is a standard, commercially available optical focusing lenses to focus the returning backscattered DIAL signal, which can be manually adjusted by the user.

In FIG. 1, item 40 is a focal plane array (FPA) used to detect the returning DIAL signal. For this application, the FPA of choice is a mercury-cadmium-telluride (MCT) photovoltaic-based detector using thermoelectric cooling. These MCT's are available commercially. Calculations show that this type of FPA has adequate detectivity to enable monitoring the SF6 leak at a range of 100's of meters. Similarly, item 41 is the same type of FPA used to monitor the output power coming from the CO2 laser, which can be omitted to save money or space, if desired. Item 42 is a charge-coupled device (CCD) to obtain a two-dimensional image (2-D) of the SF6 plume. Many CCD's are available from a variety of manufacturers for this item. FIG. 1 item 50 is the computer processor for the complete device, which has the backscattered DIAL signal (item 40) and CCD image (item 42) as inputs. The processor takes these inputs to calculate the location of the leak through the DIAL equations (see below) and produce user-friendly images. The processor also controls the diffraction grating (items 22-24). Item 51 is an amplifier to increase the DIAL signal (from item 40). Items 52-55 illustrate how the computer processor (item 50) manipulates the DIAL signal to derive the leak location, R, and associated Ps-R plot and 2-D SF6 plume image (item 56). Item 56 illustrates the type of image available for viewing by the user, which will be depicted on a standard LCD display. Item 57 is a solid-state memory stick to save the above data.

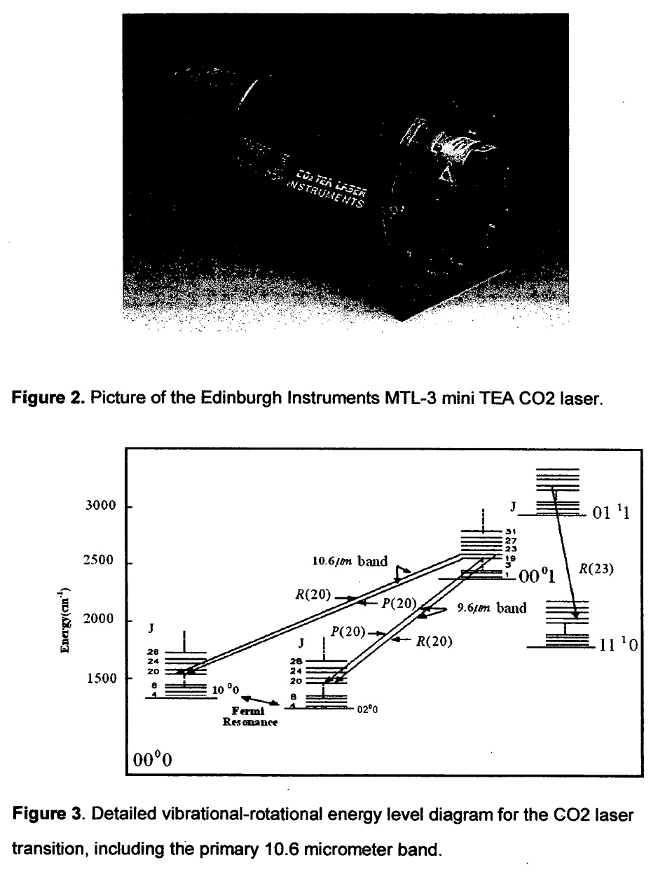

One possible choice for the mini CO2 laser is the MTL-3 laser made by Edinburgh Instruments, as shown in FIG. 2. It has built-in flexibility, being easily operated in either multi-mode or single mode, with or without grating tuning and can be delivered as either a horizontally or vertically polarized unit. Sealed, flowing gas or slow flow (gas bleed) operation further enhances the wide range of options available with the simple package when used with the optional Gas Handling System. The untuned version, operating around 10.6 μm, is rated at an output energy of 150 mJ/pulse multi-mode, or 80 mJ/pulse single transverse mode (TEMoo). The nominal pulse width is 50 ns (FWHM). The grating tuned version operates on more than 60 lines between 9.2 μm and 10.8 μm. Maximum energy is 50 mJ/pulse on the strongest lines. Other mini CO2 lasers could be substituted for the Edinburgh laser providing it has similar power available and is air-cooled. The use of such a compact, pulsed CO2 laser enables long-range measurements at several wavelengths, in contrast to other detection methods, which typically use a continuous-wave (CW) laser, which requires short range and cannot measure multiple wavelengths.

The system performance of the leak detection camera is explained here. First, a couple of laser shots are sent to the atmosphere in the direction desired for detecting a potential SF6 leak. Wavelength tuning of the laser beam (i.e. λon and λoff) is performed using the diffraction grating. If there is any SF6 leakage within the path of the laser beams, then the backscattered signals from the λon and λoff beams will differ measurably. The detected signals are collected by the Cassegrainian telescope and focused on the MCT detector (item 40) through the focusing lens (item 34). Two-dimensional imaging of the SF6 effluent is possible using raster scanning, provided the laser pulse repetition rate is synchronized with the detector frame rate (or shutter frequency). Simultaneous imaging can be done using the beam splitter (item 33) situated downstream of the telescope, which transmits part of the backscattered beam on to the CCD array having the spectral range in the infrared (9-11 micrometers) region. The amplified detected analog signals then converted to digital data through an analog-to-digital (A/D) converter to be analyzed in the computer processor. All such data are automatically stored on the storage media (item 57), which will be a solid-state memory stick.

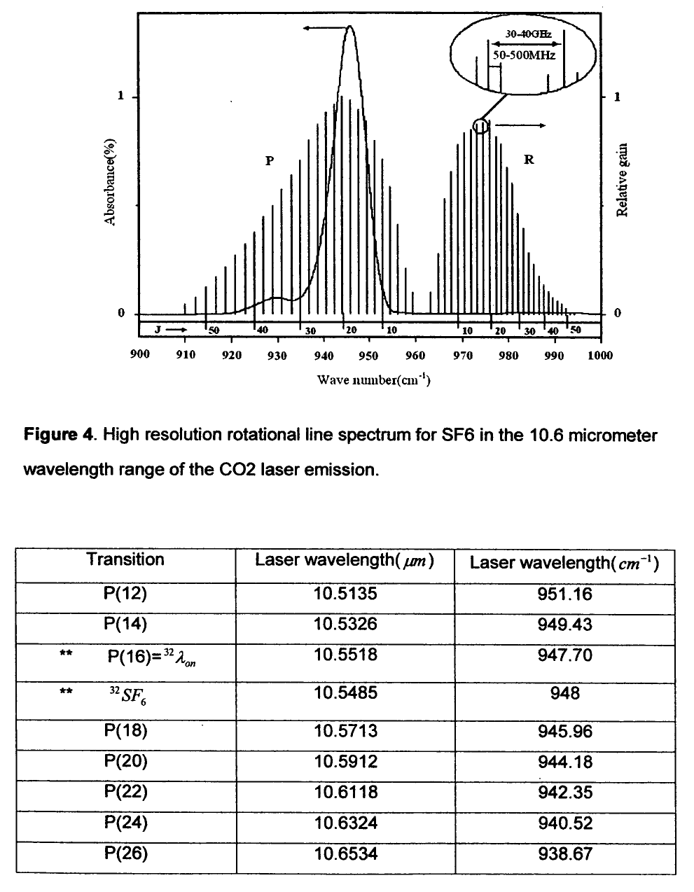

The vibrational-rotational transitions involved in producing the CO2 laser beams is shown in the energy level diagram of FIG. 3. The 10.6 micrometer emission is the one used by the laser in the present camera device. Note that light at around 10.6 micrometers can travel unimpeded through the atmosphere, or in other words the CO2 laser beams are not absorbed by the atmosphere en route to the SF6 leak. Similarly, the absorption vibrational-rotational lines of the SF6 molecule are shown in FIG. 4. Many of the rotational lines depicted in FIG. 4 for SF6 are overlapping with the CO2 emission lines around 10.6 micrometers. Thus, the CO2 laser emission around 10.6 micrometers is ideal for detecting the SF6 molecules. This is summarized in Table I, where the rotational lines for the P-branch of the CO2 laser emission are given near 10.6 micrometers, and the desired wavelengths for λon and λoff for the SF6 molecule. Note that both the 32-SF6 or 34-SF6 isotopes of the SF6 molecule can be detected, although 32-SF6 occurs naturally in greater quantity. The wavelengths desired for the DIAL measurements for SF6 leak detection are:
a) 10.2470 micrometers for the background signal (λoff)
b) 10.5518 micrometers for the DIAL signal of the 32-SF6 isotope (32-λon)
c) 10.7415 micrometers for the DIAL signal of the 34SF6 isotope (34-λon)

The elastic lidar equation may be written as:

$${P}_{s} ( {λ}_{1} , R ) = {P}_{1} \cdot \frac{{A}_{0}}{{R}^{2}} ξ ( {λ}_{1} ) β ( {λ}_{1} , R ) ξ ( R ) \frac{c {τ}_{1}}{2} {ⅇ}^{- 2 {\int }_{0}^{R} k ( {λ}_{1} , R ) ⅆ R} \qquad ( 1 )$$

P₁, A₀ and R represent the emitted pulse power (FIG. 1 item 25), the receiver telescope area and the range, respectively. ξ(λ₁) and ξ(R) are defined to be the spectral gain coefficient of the receiver and the geometrical factor of the telescope, respectively. c is the light speed and Tₗ denotes the laser pulse duration, where cT₁/2 ascertains the spatial resolution of lidar. β(λ₁,R) represents the volumetric backscatter coefficient. k(λ₁,R) is the total attenuation factor as given by:
k(λ₁,R)=kₐₜₘ(λ₁,R)+N(R)σ_{abs}(λ₁) (2)
where kₐₜₘ(λ₁,R) represents the atmospheric attenuation coefficient, and N(R) is the number density of the molecules at range R with absorption cross section σ_{abs}(λ₁). For the DIAL technique, the laser wavelength λ₁ for the absorption line of the molecule is tuned at λon while it is detuned at λoff for the non-absorptive cases.

The general equation for DIAL lidar is given by dividing two forms of the eq.1 for λon and λoff:

$$\frac{{p}_{s} ( {λ}_{on} , R )}{{p}_{s} ( {λ}_{off} , R )} = \frac{{P}_{1} ( {λ}_{on} ) ξ ( {λ}_{on} ) β ( {λ}_{on} , R ) {ⅇ}^{- 2 {\int }_{0}^{R} k ( {λ}_{on} , R ) ⅆ R}}{{P}_{1} ( {λ}_{off} ) ξ ( {λ}_{off} ) β ( {λ}_{off} , R ) {ⅇ}^{- 2 {\int }_{0}^{R} k ( {λ}_{off} , R ) ⅆ R}} \qquad ( 3 )$$

Assuming the emitted pulse powers of two signals to be identical i.e. P₁(λon)=P₁(λoff), Eq. 3 can be written as:

$$\frac{{p}_{s} ( {λ}_{on} , R )}{{p}_{s} ( {λ}_{off} , R )} = \frac{ξ ( {λ}_{on} ) β ( {λ}_{on} , R ) {ⅇ}^{- 2 {\int }_{0}^{R} k ( {λ}_{on} , R ) ⅆ R}}{ξ ( {λ}_{off} ) β ( {λ}_{off} , R ) {ⅇ}^{- 2 {\int }_{0}^{R} k ( {λ}_{off} , R ) ⅆ R}} \qquad ( 4 )$$

The concentration, N(R), of the molecule in question can be derived through Eq.4 to obtain:

$$N ( R ) = \frac{1}{2 [ {σ}_{abs} ( {λ}_{on} ) - {σ}_{abs} ( {λ}_{off} ) ]} \\ [ \frac{ⅆ}{ⅆ R} ( Ln \frac{{P}_{s} ( {λ}_{off} , R )}{{P}_{s} ( {λ}_{on} , R )} ) - \frac{ⅆ}{ⅆ R} ( Ln \frac{β ( {λ}_{off} , R )}{β ( {λ}_{on} , R )} ) ] + \\ [ {k}_{atm} ( {λ}_{off} , R ) - {k}_{atm} ( {λ}_{on} , R ) ] \qquad ( 5 )$$

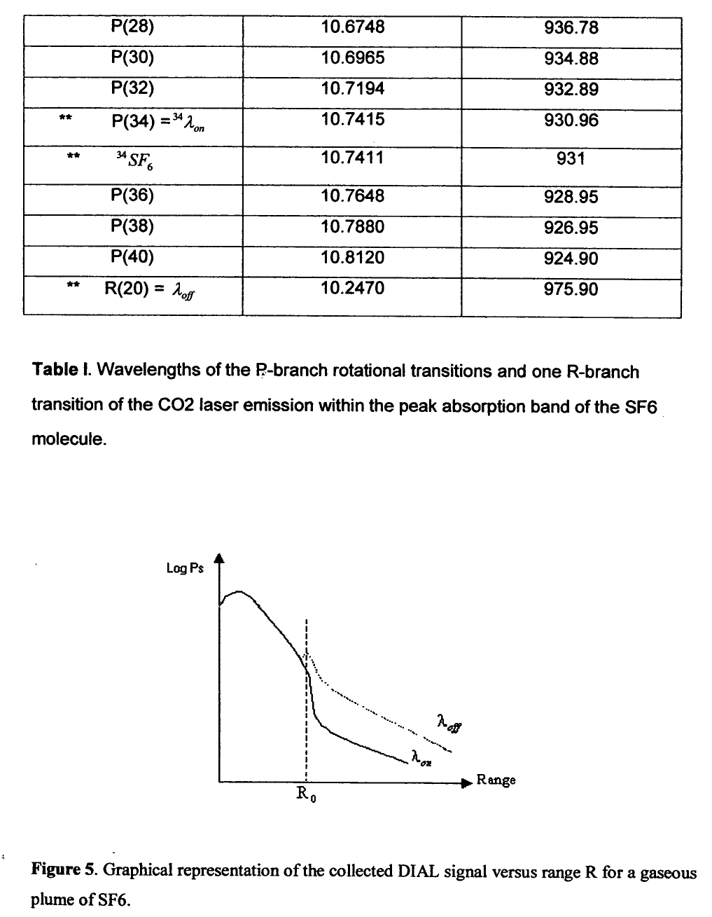

When a couple of laser pulses, one at λon and the other at λoff, are sent to the gaseous plume, then the backscattered signal at λon experiences a drop in Pₛ and the location R of the leak location, as shown in the Ps vs. R plot of FIG. 5. A drastic drop is illustrated at the SF6 effluent location (R), due to the absorption at λon, while there is not a precipitous drop due to backscattering in the gaseous plume at λoff.

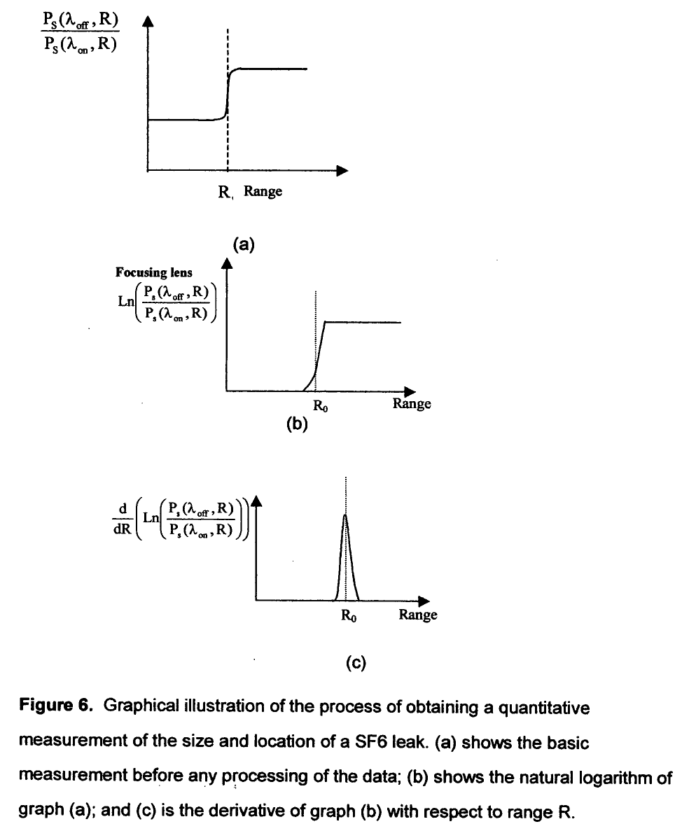

FIG. 6(a), (b) and (c) illustrate the expression of

$$\frac{{P}_{S} ( {λ}_{off} , R )}{{P}_{S} ( {λ}_{on} , R )} , ln \frac{{P}_{S} ( {λ}_{off} , R )}{{P}_{S} ( {λ}_{on} , R )} and \frac{ⅆ}{ⅆ R} [ ln \frac{{P}_{S} ( {λ}_{off} , R )}{{P}_{S} ( {λ}_{on} , R )} ] ,$$

respectively, versus range R to clarify that N(R) is strongly correlated to logarithmic derivation of the detected signal ratios

$$\frac{ⅆ}{ⅆ R} [ ln \frac{{P}_{S} ( {λ}_{off} , R )}{{P}_{S} ( {λ}_{on} , R )} ] .$$

Thus, in addition to determining the location of the SF6 leak, the concentration N(R) of the SF6 leak is directly determined by the slope of such Pₛ—R plots.

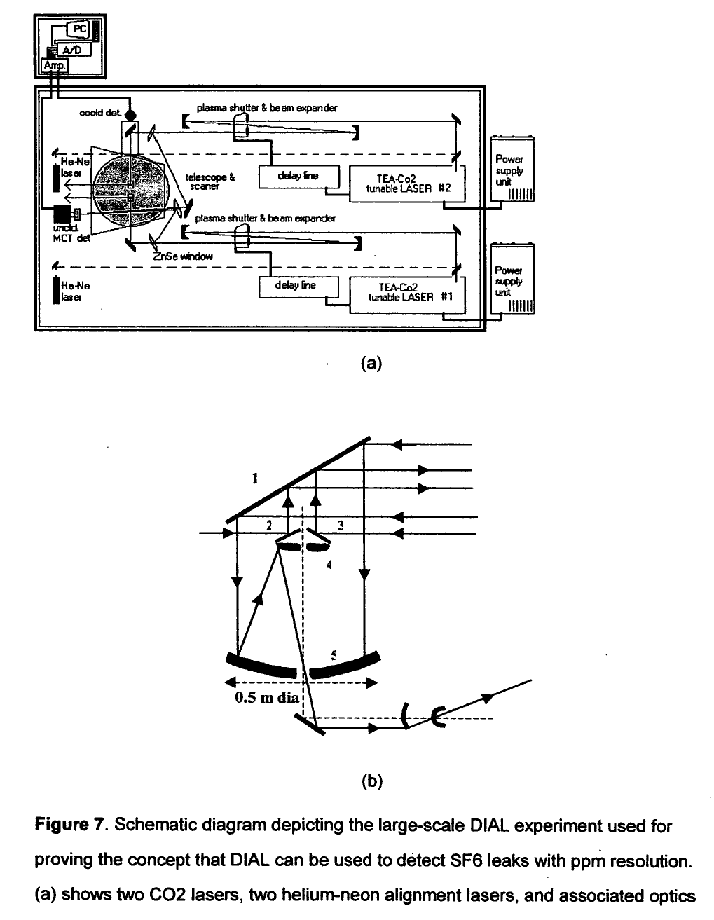

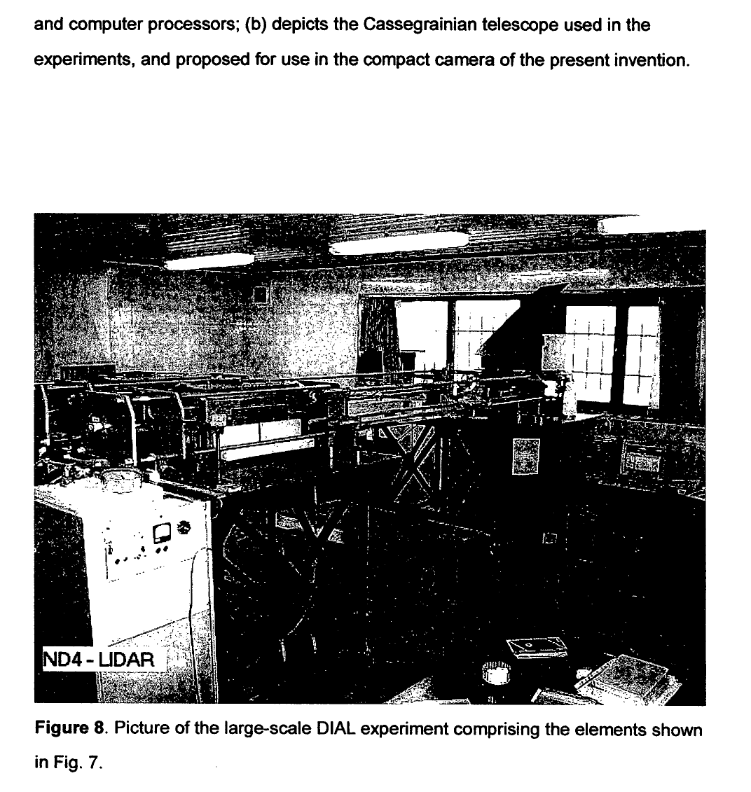

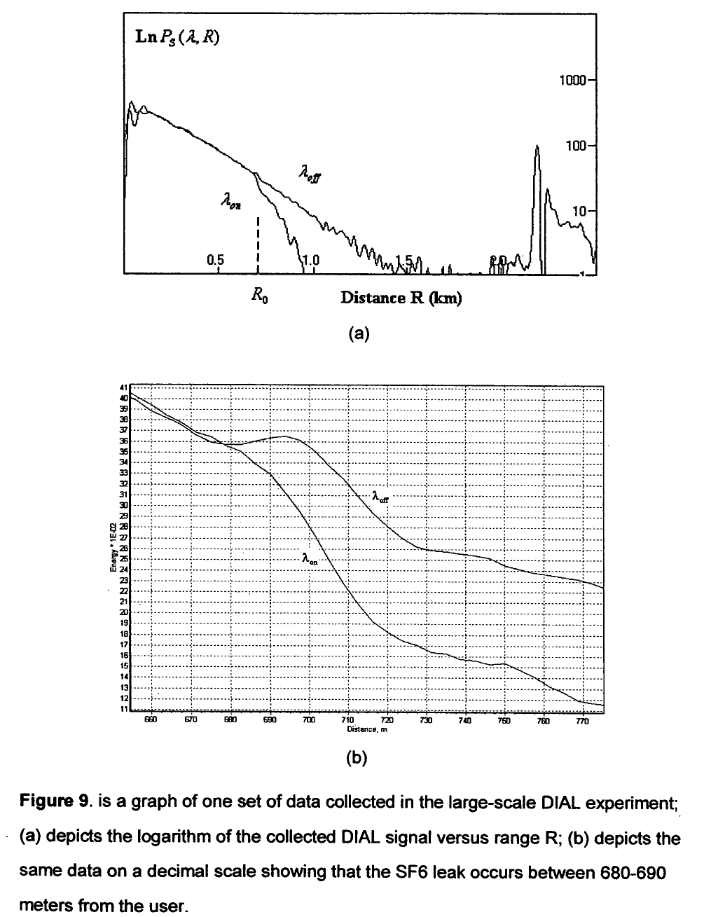

A large-scale set of experiments were conducted as a proof-of-principle in using the DIAL technique to detect SF6 at long range. This experiment is shown in FIGS. 7 and 8. The schematic of FIG. 7(a) depicts two CO2 lasers used to produce the λon and λoff beams. Note that in the new invention, rather than using two lasers as in these experiments, one compact laser which can quickly shift wavelengths will be used. The beams were directed, and the backscattered beams detected, using the same type of Cassegrainian telescope proposed for the current invention, as shown in more detail in FIG. 7(b). As shown in FIG. 8, this experiment was not compact, but was useful for demonstrating the advantages of the DIAL technique applied to SF6 detection. Actual Ps-R plots of the backscattered signals are shown in FIG. 9. These plots show that the SF6 leak location is at 680-690 meters from the experiment source location, proving the long range claimed.

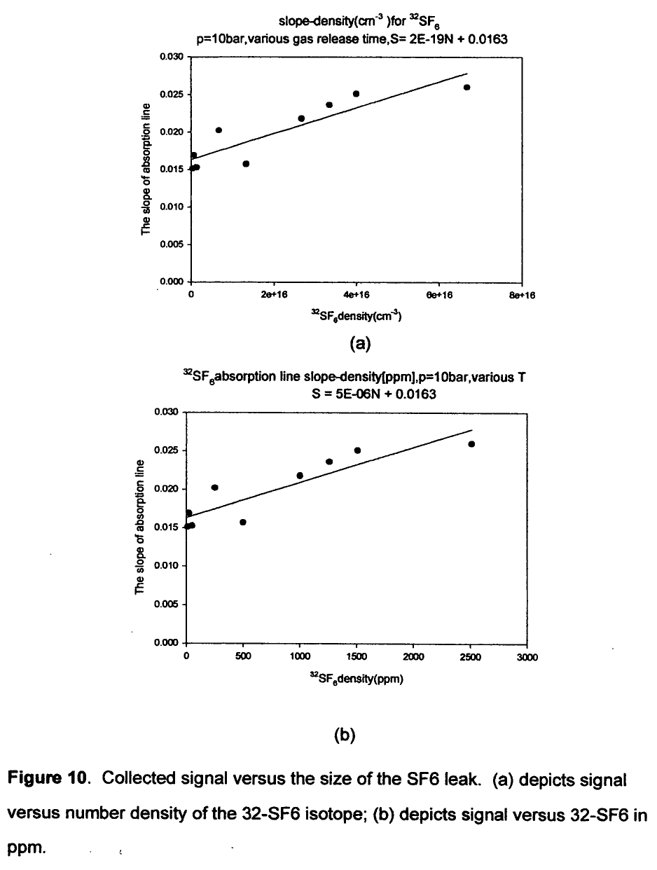

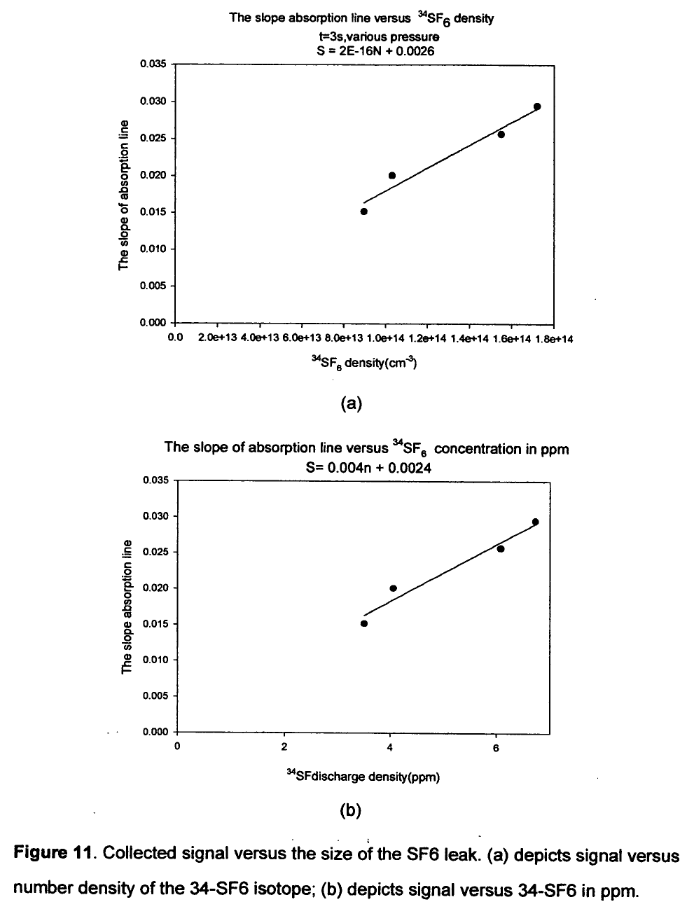

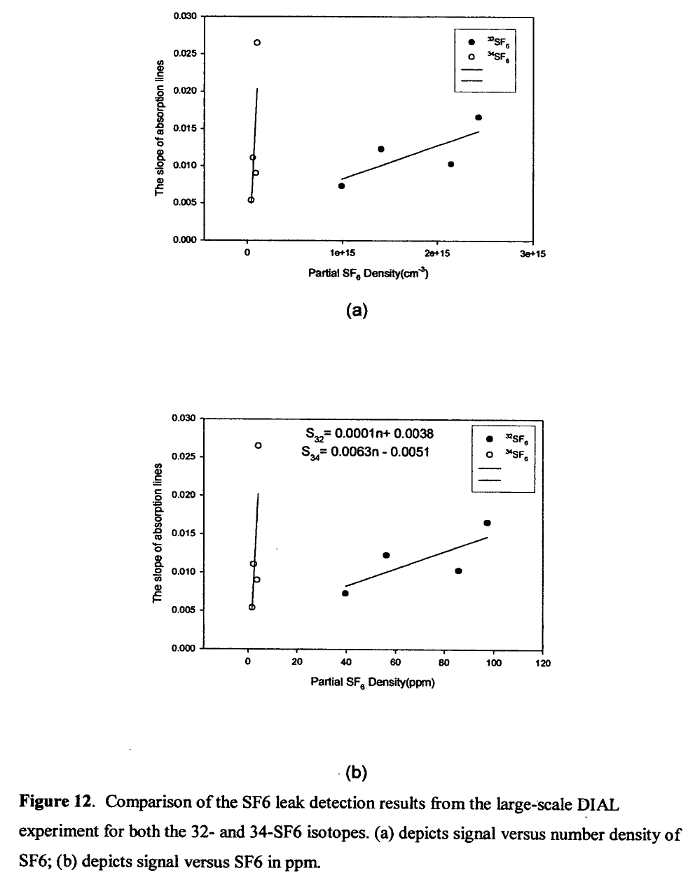

Through use of Eq. 5 above, the concentration of the SF6 leak is derived as shown in FIG. 10 for 32-SF6. This experiment confirmed that 32-SF6 can be detected and quantified to the part-per-million (ppm) resolution levels. FIG. 11 shows similar results for the 34-SF6 isotope. From these results, it was determined that the 34-SF6 isotope may be a better means of quantifying SF6 leak detection for concentrations down to the sub-ppm levels. This is highlighted in FIG. 12, which shows both results for the 32-SF6 and 34-SF6 isotopes. The reason the 34-SF6 isotope has a better signal than the 32-SF6 isotope is because although 34-SF6 is naturally of lower concentration, it has a much higher backscattering cross section than the 32-SF6 isotope. Therefore, 34-SF6 can give a better idea of low concentration leaks, whereas 32-SF6 is adequate for ranging and higher concentration levels of leaks. Note that both 32- and 34-SF6 isotope signals are easily measured simply by rotating the diffraction grating shown in FIG. 1 item 22.

The above description, and associated large-scale experiments, address the claims cited; namely that this new, mini CO2 laser-based camera system can detect sulfur hexafluoride (SF6) leaks using the infrared differential absorption lidar (DIAL) technique comprising:
a commercially available, air-cooled, compact, pulsed Transversely Excited Atmospheric (TEA) carbon dioxide (CO2) laser;
a Cassegrainian optical telescope for focusing both the laser emission and returning reflected signal;
a user-operated focusing mechanism;
a two-dimensional, thermoelectrically-cooled focal plane array (FPA) sensitive in the infrared wavelength range (10.2-10.6 micrometers);
a charge-coupled device (CCD) for 2-D imaging;
a computer-based control system to rapidly switch the laser wavelength between 10.2470 micrometers, 10.7415 micrometers, and 10.5518 micrometers to utilize the Differential Absorption Lidar (DIAL) chemical detection technique;
a rechargeable battery pack and power supply; and
an image and data storage device using a solid-state memory stick.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for detecting sulfur hexafluoride (SF6) leaks using a carbon dioxide (CO2) laser and the mid-infrared differential absorption lidar (DIAL) technique comprising:
a commercically available, air-cooled, compact, pulsed Transversely Excited Atmospheric (TEA) carbon dioxide (CO2) laser;
a Cassegeranian optical telescope for focusing both the laser emission and returning reflected signal;
a user-operated focusing mechanism;
a two-dimensional, thermoelectrically-cooled focal plane array (FPA) sensitive in the mid-infrared wavelength range (10.2-10.6 micrometers);
a charge-coupled device (CCD) for 2-D imaging;
a computer-based control system to rapidly switch the laser wavelength between 10.2470 micrometers, 10.7415 micrometers, and 10.5518 micrometers to utilize the Differential Absorption Lidar (DIAL) chemical detection technique;
a rechargeable battery pack and power supply; and
an image and data storage device using a solid-state memory stick.

2. A process for detecting sulfur hexafluoride (SF6) leaks using a carbon dioxide (CO2) laser and the mid-infrared differential absorption lidar (DIAL) technique comprising the steps of:
a commercically available, air-cooled, compact, pulsed Transversely Excited Atmospheric (TEA) carbon dioxide (CO.sub.2) laser;
a Cassegeranian optical telescope for focusing both the laser emission and returning reflected signal;
a user-operated focusing mechanism;
a two-dimensional, thermoelectrically-cooled focal plane array (FPA) sensitive in the mid-infrared wavelength range (10.2-10.6 micrometers);
a charge-coupled device (CCD) for 2-D imaging;
a computer-based control system to rapidly switch the laser wavelength between 10.2470 micrometers, 10.7415 micrometers, and 10.5518 micrometers to utilize the Differential Absorption Lidar (DIAL) chemical detection technique;
a rechargeable battery pack and power supply; and
an image and data storage device using a solid-state memory stick.
